(19) United States
(12) Patent Application Publication
(10) Pub. No.: US 2022/0032892 A1
(43) Pub. Date: Feb. 3, 2022

(54) AIR BRAKE SYSTEM

(71) Applicant: International Truck Intellectual Property Company, LLC, Lisle, IL (US)

(72) Inventor: BERNHARDT R. LABASTIDE, JR., Oswego, IL (US)

(73) Assignee: International Truck Intellectual Property Company, LLC, Lisle, IL (US)

(21) Appl. No.: 16/944,421

(22) Filed: Jul. 31, 2020

(51) Int. Cl. B60T 15/02; B60T 13/36

(52) U.S. Cl. CPC B60T 15/027; B60T 2270/402; B60T 13/36

(57) ABSTRACT

This disclosure relates to an air brake system for a vehicle having a front set of wheels having a front air brake and a rear set of wheels having a rear air brake. The air brake system comprises a front air brake cylinder included in the front air brake, and a rear air brake cylinder included in the rear air brake. A foot valve having a first side and a second side is included. A primary air tank is pneumatically connected with the second side of the foot valve, and a secondary air tank is pneumatically connected with the first side of the foot valve. A rear relay valve is pneumatically connected with second side of the foot valve and is pneumatically connected with the rear brake cylinder. A front relay valve is pneumatically connected with the first side of the foot valve and pneumatically connected with the front brake cylinder.

### BACKGROUND

This disclosure generally relates to structure and method of operation of an air brake system. More specifically, this disclosure relates to structure and method of operation of an air brake system that improves operation of a vehicle, such as a truck, a bus and the like, including an air brake system.

Drawing attention to FIG. 1, a currently available vehicle, such as a truck, a bus and the like, includes an air brake system 10 to aid control of movement of the vehicle. The air brake system 10 can affect movement of at least one of a front set of wheels and a rear set of wheels disposed on a vehicle by means of an air brake associated with each wheel. To properly control movement of the vehicle, air pressure contained in an air brake cylinder 12 is pneumatically presented to an air brake. Air pressure in the air brake cylinders 12 associated with both the front set of wheels and the rear set of wheels should be balanced appropriately. A valve 14, associated with a foot pedal operable by a vehicle user, has a 3 psi bias toward the air brakes associated with the rear set of wheels is . This air pressure bias may be offset by placing a crack pressure, e.g. 4.0 to 5.5 psi, rear relay valve 16 pneumatically connected with air brake cylinders 12 comprising air brakes associated with the rear set of wheels.

Some advanced brake features, such as stability control, collision mitigation and the like, include addition of a front relay value 18 pneumatically connected with air brake cylinders 12 associated with the front set of wheels. Addition of the front relay valve 18 may cause the air pressure bias towards the rear set of wheels to return, thereby allowing the air brakes associated with the rear set of wheels to activate prior to activation of the air brakes associated with the front set of wheels. Every time air brakes are activated on a vehicle, activation of the air brakes associated with the rear set of wheels occurs prior to activation of the air brakes associated with the front set of wheels. This can cause premature wearing of the air brakes associated with the rear set of wheels.

Accordingly, it is desirable to provide an improved structure and method of operation of an air brake system on a vehicle.

### SUMMARY

This disclosure relates to an air brake system for a vehicle having a front set of wheels having a front air brake and a rear set of wheels having a rear air brake. The air brake system comprises a front air brake cylinder included in the front air brake, and a rear air brake cylinder included in the rear air brake. A foot valve having a first side and a second side is included. A primary air tank is pneumatically connected with the second side of the foot valve, and a secondary air tank pneumatically connected with the first side of the foot valve. A rear relay valve is pneumatically connected with second side of the foot valve and is pneumatically connected with the rear brake cylinder. A front relay valve is pneumatically connected with the first side of the foot valve and pneumatically connected with the front brake cylinder.

An embodiment disclosed herein relates to an improvement to an air brake system for a vehicle having a front set of wheels having a front air brake and a rear set of wheels having a rear air brake, a front air brake cylinder included in the front air brake; a rear air brake cylinder included in the rear air brake; a foot valve having a first side and a second side, a primary air tank pneumatically connected with the second side of the foot valve, a secondary air tank pneumatically connected with the first side of the foot valve. The improvement comprises a rear relay valve pneumatically connected with second side of the foot valve and pneumatically connected with the rear brake cylinder, and a front relay valve pneumatically connected with the first side of the foot valve and pneumatically connected with the front brake cylinder.

### DESCRIPTION OF THE DRAWINGS

FIG. 1 is a schematic diagram of a current air brake system used on a vehicle; and

FIG. 2 is a schematic diagram of an air brake system comprising an embodiment disclosed herein.

### DETAILED DESCRIPTION

This disclosure relates to structure and method of operation of an air brake system that improves operation of a vehicle, such as a truck, a bus and the like, including an air brake system. For the sake of clarity, embodiments disclosed herein will focus on a tractor having six (6) wheels—two (2) on one side and four (4) on an opposite side. It is to be noted that elements of embodiments disclosed herein can be modified in any suitable way to accommodate any number of wheels on a vehicle. Also, embodiments disclosed herein may comprise those that are added to a vehicle during initial assembly of a vehicle, and those that are added to vehicle subsequent to initial assembly of a vehicle.

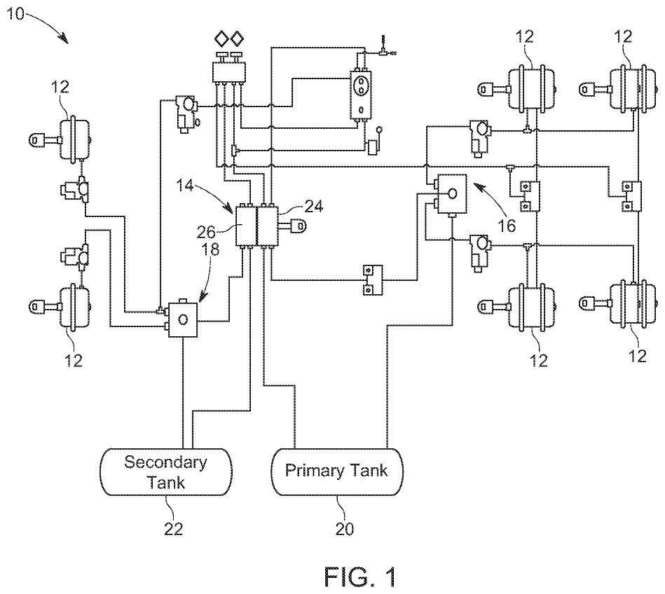

Referring to FIG. 1, the air brake system 10 includes a primary air tank 20 and a secondary air tank 22. The primary air tank 20 is pneumatically connected with a first side 24 of the foot valve 14. The first side 24 of the foot valve 14 is pneumatically connected with the rear relay valve 16. The secondary air tank 22 is pneumatically connected with a second side 26 of the foot valve 14. The second side 26 of the foot valve 14 is pneumatically connected with the front relay valve 18.

If the air brake system 10 resembles what is shown in FIG. 1, then an embodiment of the air brake system 10 disclosed herein may be subsequently added to the vehicle. To do this, the primary tank 20 is pneumatically disconnected from the first side 24 of the foot vale 14. The rear relay valve 16 is pneumatically disconnected from the first side 24 of the foot valve 14. The secondary tank 22 is pneumatically disconnected from the second side 26 of the foot valve 14. The front relay valve 18 is pneumatically disconnected from the second side 26 of the foot valve 14. The primary tank 20 is pneumatically connected with the second side 26 of the foot valve 14. The secondary tank 22 is pneumatically connected with the first side 24 of the foot valve 14. The rear relay valve 16 is pneumatically connected with the second side 26 of the foot vale 14. The front relay valve 18 is pneumatically connected with the first side 24 of the foot valve 14. This application of this embodiment of the air brake system 10 adjusts balance of the air brake system 10 thereby permitting air brakes associated with the front set of wheels to be applied prior to application of the air brakes associated with the rear set of wheels, thereby allowing the air brakes associated with the front set of wheels to do more work controlling motion of the vehicle than the air brakes associated with the rear set of wheels, thereby increasing life of the air brakes associated with the rear set of wheels. Essentially, application of an embodiment disclosed herein to a vehicle subsequent to initial assembly comprises reversal of bias of the air brake system 10.

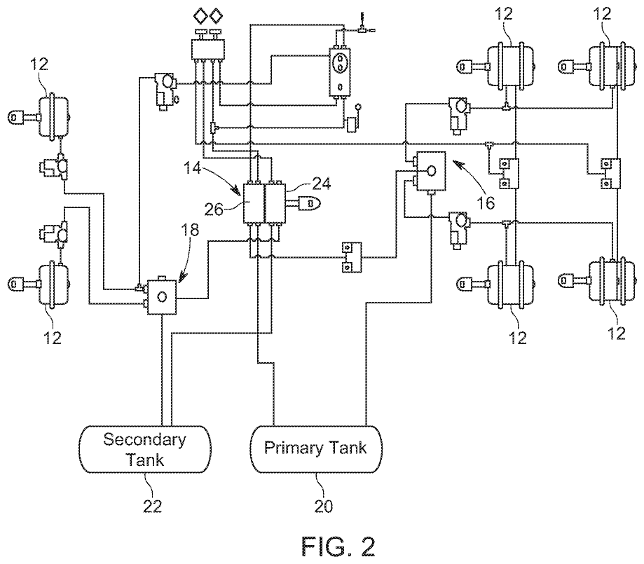

If a truck is being assembled, it is possible to implement an embodiment disclosed herein may be added to the vehicle during assembly. To do this, the primary tank 20 is pneumatically connected with the second side 26 of the foot valve 14. The secondary tank 22 is pneumatically connected with the first side 24 of the foot valve 14. At this point, the truck has an air brake system 10 as illustrated in FIG. 2.

What is claimed is:

1. An improvement to an air brake system for a vehicle having a front set of wheels having a front air brake and a rear set of wheels having a rear air brake, a front air brake cylinder included in the front air brake; a rear air brake cylinder included in the rear air brake; a foot valve having a first side and a second side, a primary air tank pneumatically connected with the second side of the foot valve, a secondary air tank pneumatically connected with the first side of the foot valve, the improvement comprising:
a rear relay valve pneumatically connected with second side of the foot valve and pneumatically connected with the rear brake cylinder; and
a front relay valve pneumatically connected with the first side of the foot valve and pneumatically connected with the front brake cylinder.

2. An air brake system for a vehicle having a front set of wheels having a front air brake and a rear set of wheels having a rear air brake, the air brake system comprising:
a front air brake cylinder included in the front air brake;
a rear air brake cylinder included in the rear air brake;
a foot valve having a first side and a second side;
a primary air tank pneumatically connected with the second side of the foot valve;
a secondary air tank pneumatically connected with the first side of the foot valve;
a rear relay valve pneumatically connected with second side of the foot valve and pneumatically connected with the rear brake cylinder; and
a front relay valve pneumatically connected with the first side of the foot valve and pneumatically connected with the front brake cylinder.
